(19) United States
(12) Patent Application Publication
(10) Pub. No.: US 2003/0031818 A1
(43) Pub. Date: Feb. 13, 2003

(54) Halogen-free intumescent sheath for wires and optical cables

(76) Inventor: Heinrich Horacek, Linz (AT)

Correspondence Address: Wenderoth Lind & Ponack LLP, 2033 K Street NW, Suite 800, Washington, DC, 20006, US

(21) Appl. No.: 09/495,944

(22) Filed: Feb. 2, 2000

(30) Foreign Application Priority Data
Feb. 3, 1999 (AT) A 138/99

(51) Int. Cl. B32B 1/08

(52) U.S. Cl. 428/36.9

(57) ABSTRACT

The invention relates to halogen-free cable sheaths for wires and optical cables which consist of a halogen-free plastic, an intumescent component and an inorganic glass former which forms a flame-resistant inorganic foam in the event of fire.

The invention relates to halogen-free, intumescent sheaths for wires and optical cables.

DE-A 36 33 056 describes extrudable mixtures for the production of a halogen-free, flame-retardant sheath for elongate products, such as electrical cables or lines and the like, where the mixture consists of a copolymer of ethylene having a monomer content of 10 -30% by weight as base material and a component which increases the heat resistance, whose proportion in the total amount of polymer is 10-50% by weight.

EP-A 0 831 120 describes a flame-inhibiting mixture for polymer components which comprises magnesium hydroxide, calcium carbonate and at least one phosphorus-containing component and at least one nitrogen-containing component.

The mixtures described do not comprise an intumescent component, which means that the function retention of the sheathed cable remains extremely short in the event of fire. In addition, a further disadvantage of these mixtures is that the protective action of limited duration drops off rapidly at high temperatures.

U.S. Pat. No. 4,728,574 claims an insulator consisting of 100 parts of ethylene-vinyl acetate and 150 parts of ammonium polyphosphate (APP).

JP 84-58899 describes a cable sheath consisting of 45% of polyethylene, 10.5% of PER, 9.5% of melamine, 20% of APP, 5% of a halogen compound and 5% of antimony pentoxide. JP 84-58900 claims a composition of analogous composition, but in crosslinked form.

U.S. Pat. No. 5,227,416, U.S. Pat. No. 5,185,102 and U.S. Pat. No. 5,130,349 provide polyethylene cable sheaths with APP and tris(2-hydroxyethyl) isocyanurate.

U.S. Pat. No. 4,328,139 describes polyolefin compositions which comprise, as intumescent flame inhibitors, acrylate polyols with P₂O₅, melamine, dicyanamide and urea.

U.S. Pat. No. 3,576,940 describes a cable which consists of a metallic conductor, insulation surrounding the conductor comprising glass fibers, silicone rubber and asbestos fibers which are impregnated with an intumescent material.

All these proposed solutions lack the glass-forming intumescent component which is capable of forming a flame-resistant inorganic foam in the event of fire. Furthermore, some of the compositions also contain halogen compounds, which release toxic gases in the event of fire and can thus result in a hazard to people and the environment.

H.-D. Fröse in Brandschutz für Kabel und Leitungen, Munich, 1998, pp. 101 ff., proposes the use of flame-protection barriers, in particular the use of glass-mica tapes, for improving function retention by cables in the event of fire. These tapes are arranged at different positions, as required, either between the inner and outer sheaths or over the insulation of the individual wires or over the conductor of each individual wire. It is stated that a disadvantage is that the flexibility of the cable is reduced, i.e. the cable becomes more rigid, and this causes additional effort during installation of the cables.

The function retention is tested in accordance with DIN 4102, Part 12. Accordingly, the cables are tested for the requisite safety with respect to any short-circuit or interruption of the current conduction in a test stand with a length of at least 3 m in accordance with a so-called standard temperature curve for a period of at least 90 minutes at temperatures of up to 1000° C. function retention on exposure of the cable to a temperature of up to 1000° C. represents the highest function retention class. Function retention in this category is required, for example, in equipment for increasing the water pressure for supply of extinguishing water, in ventilation equipment in emergency stair wells, internal stair wells, elevator shafts and their motor rooms, in smoke and heat extractors and in firefighter hoists.

The invention therefore had the object of providing a halogen-free cable sheath for wires and optical cables which retains, in the event of fire, the current- or light-conducting function of the wires or cables respectively for longer than the measures described in the prior art, namely for at least 90 minutes, and which does not impair the flexibility properties.

The invention therefore relates to halogen-free cable sheaths for wires and optical cables which consist of a halogen-free plastic, an intumescent component and an inorganic glass former which forms a flame-resistant inorganic foam in the event of fire.

Suitable halogen-free plastics are thermoplastics and elastomers, such as, for example, polyethylene, polyvinyl acetate copolymers, ethylene-acrylate copolymers, ethylene-ethyl acrylate copolymers, ethylene-butyl acrylate polymers, polypropylene, polyamide, natural rubber, butyl rubber, styrene-butadiene rubber, nitrile rubber, ethylene-propylene rubber, EPDM-rubber, ethylene-propylene terpolymer rubber, silicone rubber, thermoplastic polyurethane and mixtures thereof, for example mixtures of polyethylenes with rubbers.

Suitable intumescent flame inhibitors are ammonium polyphosphate, melamine and dipentaerythritol, phosphoric acid esters of polyalcohols, such as glycerol phosphate and sorbitol phosphate, guanidine-formaldehyde resin phosphates, melamine-formaldehyde resin phosphates, compacted graphites, water-glass and expandable mica, and mixtures thereof.

The inorganic glass formers used are salts of boric acid, such as, for example, zinc borate or calcium borate, salts of silicic acid, such as wollastonite, kaolin, clay or frit, or salts of phosphoric acid, such as calcium phosphate, magnesium phosphates, zinc phosphate, aluminum phosphate or aluminum dihydrogen phosphate.

The plastic mixtures can furthermore contain conventional fillers, antioxidants, stabilizers, adhesion promoters, crosslinking agents, plasticizers, and the like.

Examples of such fillers are calcium carbonate, magnesium carbonate, aluminum oxide hydrates, magnesium hydroxides, chalk, talc, zinc oxide and the like, and mixtures thereof.

Suitable antioxidants are Irganox 1010®, pentaery-thritol tetrakis-3,5-di-tert-butyl-4-hydroxypropionate, dilauryl thiopropionate and the like.

The adhesion promoters employed are usually silanes, for example vinyltris(t-butyl)peroxysilane.

Suitable crosslinking agents are peroxides, for example benzoyl peroxide, 2,5-dimethyl-2,5-di(t-butylperoxy)-hexane, dicumyl peroxide or bis(t-butylperoxypropyl)-benzene, or hydrolyzable silanes, for example tris(t-butyl)vinylsilane, or ethoxy- or methoxyvinylsilanes, such as Silane A 172.

The plasticizers employed are conventional plasticizers, for example paraffin oils, paraffin waxes or stearic acid.

The stabilizers employed are 2,6-di-t-butylcresol, tris (nonylphenyl) phosphite, distearyl pentaerythritol diphosphite and the like.

In accordance with the invention, the proportion of plastic in the composition is 20-50% by weight, preferably 25-35% by weight, the proportion of the inorganic glass former is 20-35% by weight, preferably 25-30% by weight, and the proportion of the intumescent component is 20-35% by weight, preferably 25-30% by weight.

The sheath is produced by the processes described in Encyclopedia of Chemical Technology, Vol. 14, 4th Edn., J. Wiley and Sons, New York (1995), p. 640, and in Encyclopedia of Polymer Science and Engineering, 2nd Edn., Vol. 17, J. Wiley and Sons, New York (1989), p. 828.

The plastics described above are crosslinked, alone or in a mixture, by means of peroxides or using silanes. To this end, the plastic component, the intumescent component and the glass former are mixed with the crosslinking agent in an extruder. The homogeneous composition is shaped around the wire or optical cable and, if necessary, subsequently treated with steam to effect the crosslinking.

An optical cable has a complex construction.

The glass fiber is coated with silicone, which cures thermally or by means of UV irradiation, or with a hot-melt adhesive rubber or a UV-curing polyacrylate as primary coating and with nylon or polyacrylate as secondary coating. The filling material used is oil-diluted polybutylene.

A polypropylene tube surrounds the entire structure. An adhesive tape consisting of a support of oriented polyethylene terephthalate and a pressure-sensitive acrylate adhesive is wrapped around a number of such tubes. The reinforcing material used comprises aramid, steel or glass fibers.

The sheathing is carried out, as in the case of copper cables, with thermoplastics, such as polyethylene, PVC or thermoplastic polyurethane, by extrusion.

Optical cables produced as described in Encyclopedia of Polymer Science and Engineering, 2nd Edn., Vol. 7 (1989), J. Wiley and Sons, New York, pages 1 ff. were sheathed with thermoplastic polyurethane which had been provided with the finish according to the invention.

The cables produced in this way were tested for function retention in the event of fire in accordance with DIN 4102 Part 12.

### Preparation Process 1

In a twin-screw extruder, polyethylene was compounded with an intumescent mixture comprising ammonium polyphosphate, dipentaerythritol and melamine, calcined clay as glass former and peroxides as crosslinking agents, together with paraffin wax, stearin and antioxidants, to give a homogeneous composition. The extrudate was subsequently shaped at 130° C. to give a wire sheath and placed around the metallic wire. The wire insulated in this way was fed into a tube with a length of 125 m which was filled with superheated steam at 20 bar. The crosslinking of the cable sheath was carried out at 210° C.

### Preparation Process 2

In a twin-screw extruder, the EPDM Nordel 4167 was compounded with neopentyl glycol phosphate as intumescent compound, zinc borate as glass former and trialkoxyvinylsilane as crosslinking agent, in addition to antioxidants and LDPE, to give a homogeneous composition.

The hydrolysis to give silanol groups was carried out in the presence of water and a condensation catalyst, such as titanates, followed by condensation of the silane compounds. The remainder of the procedure corresponded to that described in Example 1 above.

The function retention in the event of fire was in each case tested in accordance with DIN 4102 Part 12.

The following compositions were prepared in accordance with one of the two examples.

The extrusion temperature was about 200° C. and was matched to the elastomer or thermoplastic used. In the case of the polyethylene-vinyl acetate Levaprem 500 HV (Bayer), the material temperature was 280° C. and the die temperature was 220° C.; in the case of the thermoplastic polyurethane Elastollan 1185 A10 (BASF), the material temperature was 200° C. and the die temperature was 180° C.; in the case of the EPDM rubbers Nordel IP 3720 and 4167 (DuPont), the material temperature was 200° C. and the die temperature was 220° C.; and in the case of the polyolefin elastomer Engage 8200, the material temperature was 190° C. and the die temperature was 210° C.

### EXAMPLE 1

| Composition | Parts |
|---|---|
| Rubber: Nordel 4167 ® | 100 |
| LDPE: Daplen 2410F ® | 10 |
| Inorganic glass former: clay | 100 |
| Intumescent compound: DPER:M:APP = 1:2:6 | 100 |
| dipentaerythritol:melamine:ammmonium poly- | |
| phosphate | |
| Paraffin wax | 3 |
| Paraffin oil | 50 |
| Stearic acid | 2 |
| Zinc oxide | 2 |
| Antioxidant: pentaerythritol tetrakis(3,5-di- | 1 |
| t-butyl-4-hydroxyphenylpropionate):dilauryl | |
| thiopropionate = 1:1 | |
| Adhesion promoter: vinyltris(t-butyl)peroxy- | 2 |
| silane | |
| Crosslinking agent: bis(t-butylperoxy- | 5 |
| isopropyl) benzene | |

Function retention in accordance with DIN 4102 Part 12: 120 minutes

### EXAMPLE 2

| Composition | Parts |
|---|---|
| Rubber: Levapren HU 500 ® | 100 |
| Inorganic glass former: zinc borate | 100 |
| Intumescent compound: NPGP (neopentyl glycol | 100 |
| phosphate) | |
| Paraffin wax | 5 |
| Paraffin oil | 40 |
| Stearic acid | 2 |
| Zinc oxide | 1 |
| Antioxidant: pentaerythritol tetrakis(3,5-di- | 1 |
| t-butyl-4-hydroxyphenylpropionate):dilauryl | |
| thiopropionate = 1:1 | |
| Adhesion promoter: vinyltris(t-butyl)peroxy | 1 |
| silane | |
| Crosslinking agent: tris-t-butylvinylsilane | 6 |

Function retention in accordance with DIN 4102 Part 12: 150 minutes

### EXAMPLE 3

| Composition | Parts |
|---|---|
| Rubber: Levapren HU 500 ® | 100 |
| Inorganic glass former: aluminum dihydrogen | 100 |
| phosphate | |
| Intumescent compound: guanidine-formaldehyde | 100 |
| resin phosphate | |
| Paraffin wax | 5 |
| Paraffin oil | 40 |
| Stearic acid | 2 |
| Zinc oxide | 1 |
| Antioxidant: pentaerythritol tetrakis(3,5-di- | 1 |
| t-butyl-4-hydroxyphenylpropionate):dilauryl | |
| thiopropionate = 1:1 | |
| Adhesion promoter: vinyltris(t-butyl)peroxy- | 2 |
| silane | |
| Crosslinking agent: bis(t-butylperoxy- | 5 |
| isopropyl) benzene | |

Function retention in accordance with DIN 4102 Part 12: 130 minutes

### EXAMPLE 4

| Composition | Parts |
|---|---|
| Rubber: Levapren HU 500 ® | 100 |
| Inorganic glass former: borax | 100 |
| Intumescent compound: melamine-formaldehyde | 100 |
| resin phosphate (MFP) | |
| Paraffin wax | 5 |
| Paraffin oil | 40 |
| Stearic acid | 2 |
| Zinc oxide | 1 |
| Antioxidant: pentaerythritol tetrakis(3,5-di- | 1 |
| t-butyl-4-hydroxyphenylpropionate):dilauryl | |
| thiopropionate = 1:1 | |
| Adhesion promoter: vinyltris(t-butyl)peroxy- | 2 |
| silane | |
| Crosslinking agent: bis(t-butylperoxy- | 6 |
| isopropyl) benzene | |

Function retention in accordance with DIN 4102 Part 12: 120 minutes

### EXAMPLE 5

| Composition | Parts |
|---|---|
| Rubber: Nordel IP 3723P ® | 100 |
| LDPE: Daplen 2410F ® | 20 |
| Inorganic glass former: wollastonite | 100 |
| Intumescent compound: DPER:M:APP = 1:2:6 | 100 |
| Paraffin wax | 5 |
| Paraffin oil | 50 |
| Stearic acid | 1 |
| Zinc oxide | 3 |
| Antioxidant: Irganox 1010:Tinuvin P = 1:1 | 2 |
| Adhesion promoter: vinyltris(t-butyl)peroxy- | 3 |
| silane | |
| Crosslinking agent: bis(t-butylperoxy- | 5 |
| isopropyl) benzene | |

Function retention in accordance with DIN 4102 Part 12: 110 minutes

### EXAMPLE 6

| Composition | Parts |
|---|---|
| Rubber: Nordel IP 3720 ® | 100 |
| LDPE: Daplen 2410F ® | 10 |
| Inorganic glass former: kaolin | 100 |
| Intumescent compound: NPGP | 50 |
| Paraffin wax | 10 |
| Paraffin oil | 25 |
| Stearic acid | 1 |
| Zinc oxide | 1 |
| Antioxidant: Irganox 1010:Tinuvin P = 1:1 | 1 |
| Adhesion promoter: vinyltris(t-butyl)peroxy- | 2 |
| silane | |
| Crosslinking agent: bis(t-butylperoxy- | 4 |
| isopropyl) benzene | |

Function retention in accordance with DIN 4102 Part 12: 120 minutes

### EXAMPLE 7

| Composition | Parts |
|---|---|
| Rubber: Engage 8200 ® | 100 |
| LDPE: Daplen 2410F ® | 30 |
| Inorganic glass former: aluminum dihydrogen | 100 |
| phosphate | |
| Intumescent compound: NPGP | 100 |
| Paraffin wax | 5 |
| Paraffin oil | 40 |
| Stearic acid | 1 |
| Zinc oxide | 0 |
| Antioxidant: Irganox 1010:Tinuvin P = 1:1 | 1 |
| Adhesion promoter: vinyltris(t-butyl)peroxy- | 3 |
| silane | |
| Crosslinking agent: bis(t-butylperoxy- | 3 |
| isopropyl) benzene | |

Function retention in accordance with DIN 4102 Part 12: 130 minutes

### EXAMPLE 8

| Composition | Parts |
|---|---|
| Rubber: Levapren HU 600 ® | 100 |
| LDPE: Daplen 2410F ® | 20 |
| Inorganic glass former: clay:zinc borate = 1:1 | 100 |
| Intumescent compound: sorbitol phosphate | 100 |
| Paraffin wax | 0 |
| Paraffin oil | 30 |
| Stearic acid | 1 |
| Zinc oxide | 5 |
| Antioxidant: Irganox 1010:Tinuvin P = 1:1 | 2 |
| Adhesion promoter: vinyltris(t-butyl)peroxy- | 2 |
| silane | |
| Crosslinking agent: bis(t-butylperoxy- | 5 |
| isopropyl) benzene | |

Function retention in accordance with DIN 4102 Part 12: 125 minutes

The following examples describe optical cable sheaths according to the invention.

### Example 9

| Composition | Parts |
|---|---|
| Rubber: Elastollan 1185 A 10 | 100 |
| Inorganic glass former: kaolin | 100 |
| Intumescent compound: DPER:M:APP = 1:2:6 | 100 |
| Stearic acid | 1 |
| Antioxidant: 2,6-di-t-butyl-p-cresol | 0.1 |
| Adhesion promoter: γ-aminopropyltriethoxy- | 0.5 |
| silane | |

Function retention in accordance with DIN 4102 Part 12: 100 minutes

### Example 10

| Composition | Parts |
|---|---|
| Rubber: Elastollan 1185 A 10 | 100 |
| Inorganic glass former: zinc borate | 100 |
| Intumescent compound: NPGP | 100 |
| Stearic acid | 1 |
| Antioxidant: 4,4-di-t-octyldiphenylamine | 0.1 |
| Adhesion promoter: N-β-aminoethyl-y-amino- | 0.5 |
| propyltrimethylsilane | |

Function retention in accordance with DIN 4102 Part 12: 110 minutes

### EXAMPLE 11

| Composition | Parts |
|---|---|
| Rubber: Elastollan 1185 A 10 | 100 |
| Inorganic glass former: Na/Al silicate | 100 |
| Intumescent compound: GFP | 100 |
| Stearic acid | 1 |
| Antioxidant: 2,6-di-t-butyl-p-cresol | 0.1 |
| Adhesion promoter: N-β-aminoethyl-γ-amino- | 0.5 |
| propyltrimethylsilane | |

Function retention in accordance with DIN 4102 Part 12: 120 minutes

### Example 12

| Composition | Parts |
|---|---|
| Rubber: Elastollan 1185 A 10 | 100 |
| Inorganic glass former: wollastonite | 100 |
| Intumescent compound: MFP | 100 |
| Stearic acid | 1 |
| Antioxidant: 2,6-di-t-butyl-p-cresol: 4,4-di-t- | 0.1 |
| octyldiphenylamine = 1:1 | |
| Adhesion promoter: γ-aminopropyltriethoxy- | 0.5 |
| silane | |

Function retention in accordance with DIN 4102 Part 12: 115 minutes

1.) A halogen-free cable sheath for wires and optical cables which consists of a halogen-free thermoplastic or elastomer, an intumescent component and an inorganic glass former which forms a flame-resistant inorganic foam in the event of fire.

2.) A halogen-free cable sheath as claimed in claim 1, wherein the proportion of halogen-free plastic is 20-50% by weight, the proportion of the inorganic glass former is 20-35% by weight, and the proportion of the intumescent component is 20-35% by weight.

3.) A halogen-free cable sheath as claimed in claim 1, wherein the proportion of halogen-free plastic is 25-35% by weight, the proportion of the inorganic glass former is 25-30% by weight, and the proportion of the intumescent component is 25-30% by weight.

4.) A halogen-free cable sheath as claimed in one of claims 1 to 3, wherein the halogen-free plastic employed is a polyethylene, polypropylene, polyvinyl acetate, EPDM-rubber, polyolefin elastomer, thermoplastic polyurethane or natural rubber.

5.) A halogen-free cable sheath as claimed in one of claims 1 to 4, wherein the plastic employed is a mixture of rubber and polyethylene.

6.) A halogen-free cable sheath as claimed in one of claims 1 to 5, wherein the intumescent component employed is ammonium polyphosphate, melamine, dipentaerythritol, a phosphoric acid ester of a polyalcohol, a guanidine-formaldehyde resin phosphate or a melamine-formaldehyde resin phosphate, or a mixture thereof.

7.) A halogen-free cable sheath as claimed in one of claims 1 to 6, wherein the inorganic glass former employed is a borate, phosphate or silicate.

8.) A halogen-free cable sheath as claimed in one of claims 1 to 7, which is crosslinked by addition of a peroxide or hydrolyzable silane compound.

9.) A halogen-free cable sheath as claimed in one of claims 1 to 8, which additionally contains a filler.

10.) A halogen-free cable sheath as claimed in one of claims 1 to 9, wherein the cable sheath additionally contains a plasticizer, stabilizer and antioxidant.

| O.Z.1184 | |
|---|---|
| 23.11.1999 | DSM Fine Chemicals Austria GmbH |
